(19) United States
(12) Patent Application Publication
(10) Pub. No.: US 2019/0009703 A1
(43) Pub. Date: Jan. 10, 2019

(54) SYSTEM AND METHOD OF TRANSPORTING

(71) Applicant: Wayne Waggoner, Billings, MO (US)

(72) Inventor: Wayne Waggoner, Billings, MO (US)

(21) Appl. No.: 15/379,439

(22) Filed: Dec. 14, 2016

(51) Int. Cl. B60P 3/08; B60P 3/07; B62D 53/08; B62D 53/06

(52) U.S. Cl. CPC B60P 3/08; B62D 53/06; B62D 53/08; B60P 3/07

(57) ABSTRACT

A system and method for transporting a plurality of automobiles on a stinger semi-trailer with a class 8 standard semi-trailer truck with a fifth wheel above the wheels.

### BRIEF DESCRIPTION OF THE DRAWINGS

For a more complete understanding of the present invention, including its features and advantages, reference is now made to the detailed description of the invention taken in conjunction with the accompanying drawing in which:

FIG. 1 illustrates a system of loading and transporting automobiles on a stinger trailer using a standard Class A semi-trailer truck with high mount fifth wheel;

FIG. 2 illustrates part of the standard semi-trailer truck with the present invention;

FIG. 3 illustrates the standard semi-trailer truck and the stinger convertor with a stinger trailer loaded with automobiles;

FIGS. 4A and 4B illustrates how an automobile may be loaded on the semi-trailer truck that has the stinger convertor installed; and

FIGS. 5-8 illustrate close-ups of the stinger convertor assembled on the semi-trailer truck.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

A car carrier trailer, known variously as a stinger car-carrying trailer, car hauler, auto transport trailer, etc., is a type of trailer or semi-trailer designed to efficiently transport passenger vehicles via truck.

Modern car carrier trailers can be open or enclosed. Most commercial trailers have built-in ramps for loading and off-loading cars, as well as power hydraulics to raise and lower ramps for stand-alone accessibility.

Commercial-size car carrying trailers are commonly used to ship new cars from the manufacturer to auto dealerships; in the U.S., shipping of used vehicles is also a big industry, employed by car owners who are relocating and choose to ship their cars instead of driving, as well as consumers who have just purchased a vehicle on the second-hand market (particularly online) and need it delivered to their location.

Like other semi-trailers, most commercial car carrier trailers attach to the tractor using a fifth wheel coupling. Trailers can either be enclosed, possessing walls like a conventional box trailer, which affords the shipped vehicles more protection at the cost of lower capacity; or open, as in the commonly seen skeletal tube steel design, which exposes the vehicles to the elements but allows for greater carrying capacity. An American commercial car carrier typically fits between 5 to 9 cars, depending on the car size and trailer model (capacity is limited by an 80,000 lb. weight cap that a road vehicle is subject to under U.S. law). Significantly higher-capacity vehicles have been observed around the world, such as a side-by-side loading Chinese model.

Open commercial car carrier trailers typically have a double-decker design, with both decks subdivided into a variety of loading and storage ramps that can be tilted and lifted independently of one another with hydraulics. Unlike flatbed tow trucks, which often need to transport non-running vehicles, car carrier trailers are not equipped with loaders or winches, instead relying on the vehicles to be loaded under their own power. The trailer hydraulics allow the ramps to be aligned on a slope so cars can be driven up and secured to the ramp floor with chains, tie-down ratchets or wheel straps, after which the ramp can be tilted in any direction to optimize stacking.

To load vehicles on the top deck of a double-decker commercial trailer, the rear half of the deck can tilt and be lowered hydraulically, forming a drive-up ramp to the upper deck. The top deck is usually loaded first and off-loaded last, since the presence of cars on the lower deck can make it impossible to lower the top deck ramp. Trailer hydraulics are usually operated using a control box mounted on the trailer itself.

One common issue is how to use one of these commercial class 8 trailer with a high mount installed fifth wheel with a stinger type semi-trailer. Stinger type semi-trailers are commonly used for transporting cars, but need to be attached to a semi-trailer truck that has lower fifth wheel assembly behind the rear axle.

There are many configurations that have been developed to transport these types of cars, with use of commercial trailer with a fifth wheel installed above the tandem wheels, but they are usually custom made to fit an individual trailer and not usable on other high mount fifth wheel semi-trailers. Although new systems and methods of utilizing a commercial trailer with this type of configuration are constantly being developed, an efficient and universal fifth wheel convertor for a stinger trailer needs to be developed in order to achieve even more cost savings. Accordingly, a new system and method has been developed and is an embodiment of the present invention.

The present invention includes a regular class 8 commercial trailer 100 and a stinger convertor 200 that attaches the commercial trailer's fifth wheel to a stinger trailer 110.

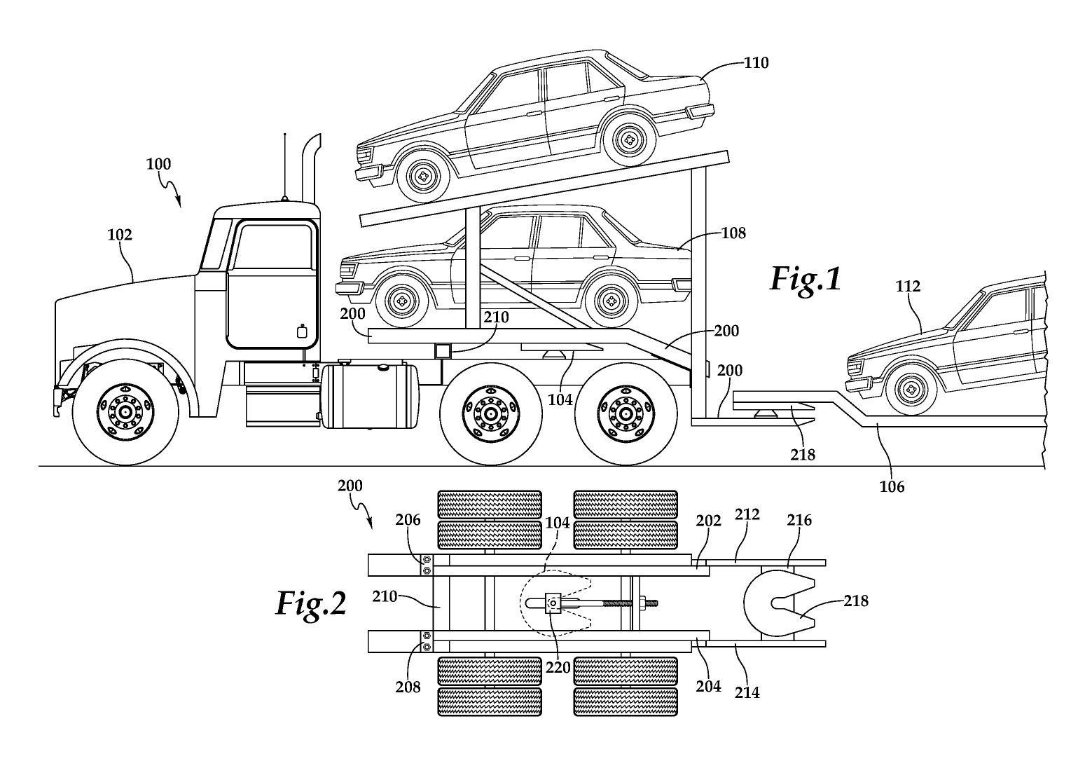

Now referring to FIG. 1, a configuration 100 of a semi-trailer truck 102 is shown having a fifth wheel assembly 104. In addition, a stinger trailer 106 is connected and hauled with a stinger convertor 200 attached onto the fifth wheel assembly 104. Moreover, a first 108 and a second 110 automobile are stacked on the semi-trailer truck. Also shown, is a lower fifth wheel assembly 218 that attaches the stinger type trailer onto the stinger convertor 200. FIG. 1 also shows an automobile 112 on the stinger type trailer, but others that are not shown would usually be loaded on the stinger trailer 106 up to seven automobiles.

FIG. 2 shows more details of the stinger convertor 200 and part of a standard semi-trailer truck 102 and the fifth wheel assembly 104 attached thereto. Also shown is right side bar 202 and left side bar 204 attached to the semi-trailer truck 102 by right attachment 206 and left attachment 208 and front cross bar 210. Moreover, a rear cross bar 220 is attached to the right side bar 202 and the left side bar 204. The rear cross bar 220 also has a attachment bar 222 with a sliding adjustable kingpin 224 that locks onto the semi-trailer fifth wheel assembly 104. The sliding adjustable kingpin 224 can move to fit the fifth wheel assembly 104 since not all fifth wheel assemblies are identically placed in the same place on a semi-trailer truck 102. However, the sliding adjustment also has a locking pin (not shown) that securely locks the sliding kingpin 224 onto the fifth wheel assembly 104. In addition, the lower fifth wheel assembly 218 is shown attached to lower cross bar 216 which is attached to right lower side bar 212 and left lower side bar 214.

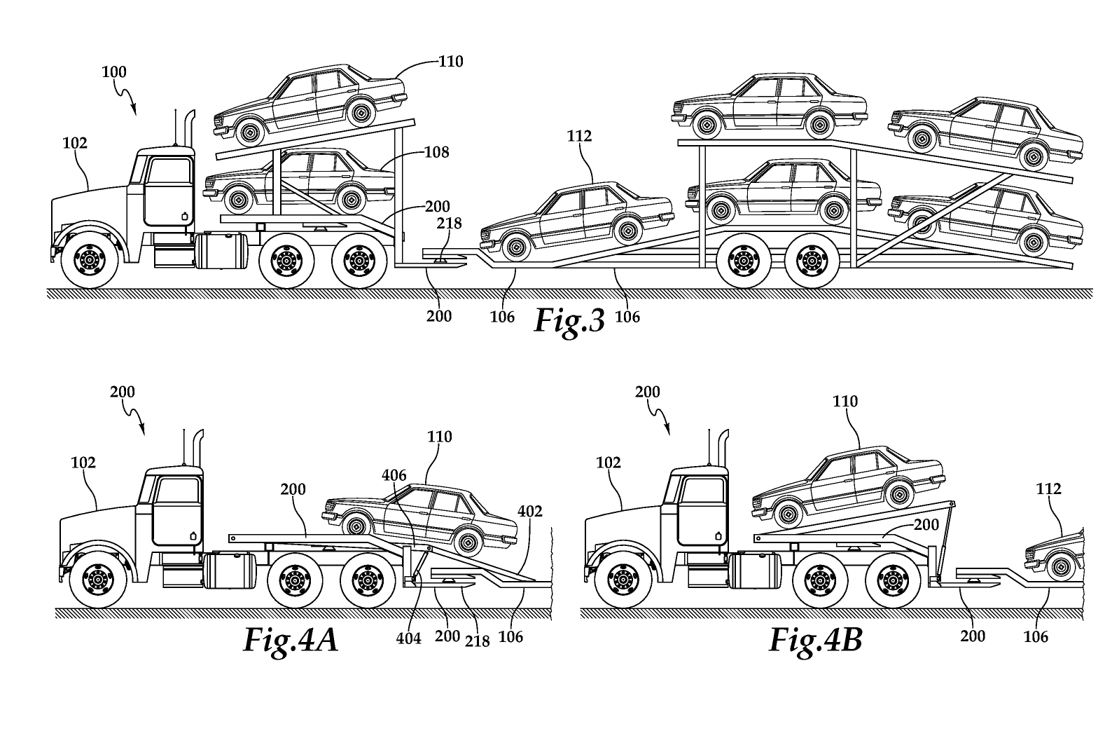

FIG. 3 illustrates a configuration wherein the semi-trailer truck 102 with a stinger convertor 200 and a fully loaded stinger trailer 106 attached thereto,

FIG. 4A illustrates how a first automobile 110 can be loaded onto the semi-trailer truck 102 with a stinger convertor 200 and an attached stinger trailer 106. This figure shows a portable ramp 402 attached to a platform 406 and a hydraulic arm 404 that lifts the portable ramp 402 and the platform 406 to load an automobile 110.

FIG. 4B illustrated the automobile 110 in a loaded position. Note that the portable ramp 402 is removed after loading the automobile 110 and not shown in this figure.

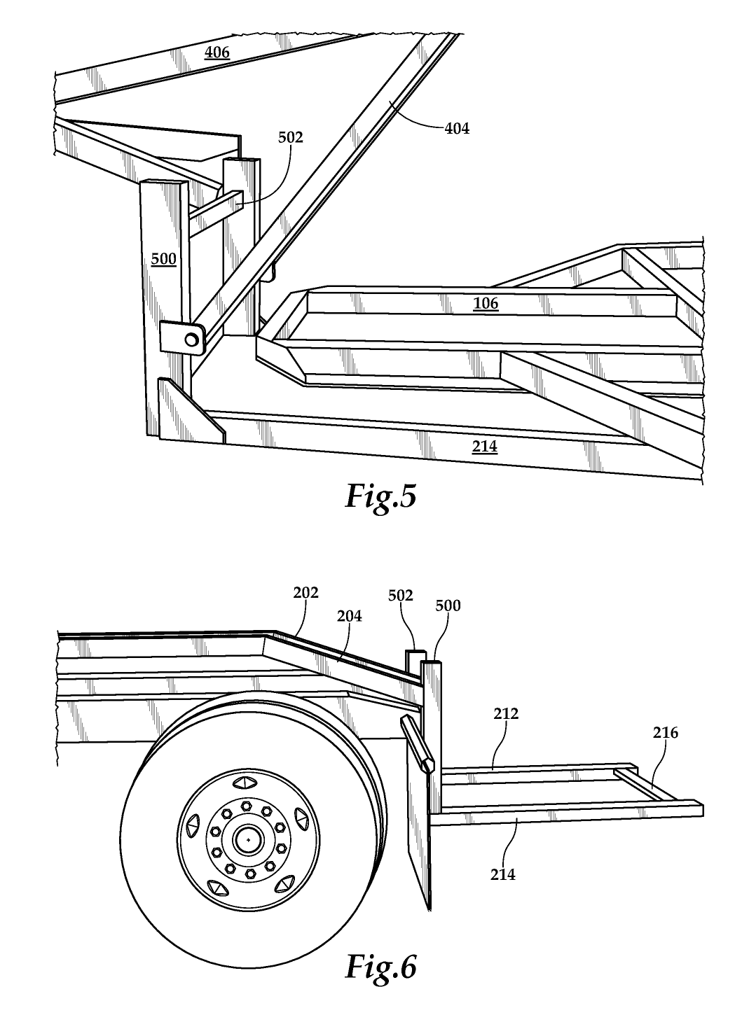

FIG. 5 illustrates a close-up stinger convertor and the stinger trailer 106. In this figure, the hydraulic arm 404 and platform 406 are shown with vertical bars 500 and 502. Attached in between the vertical bars 500, 502 is another connecting bar 506.

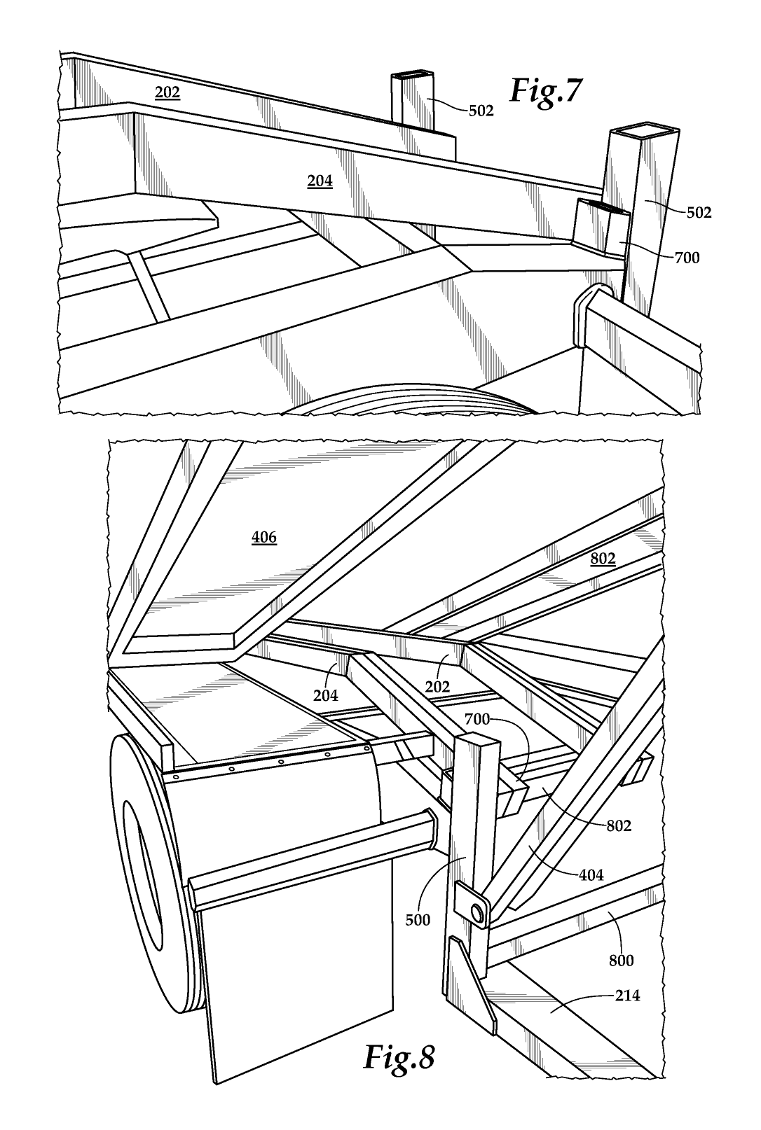

FIG. 6 illustrates another side view of the semi-trailer truck 102 and the stinger convertor 200. However, in this figure, support structure 700 is shown to help support the weight of the stinger convertor 200 onto the semi-trailer truck 102.

FIG. 7 illustrates another view of the stinger convertor 200 shown assembled

FIG. 8 illustrates another view of the stinger convertor 200 with a left portion 406 of a platform along with a right portion of the platform that is used to load an automobile 102 onto the semi-trailer truck 102. Although hydraulic arm 404 is shown attached to the vertical bar 500 on the inside the tandem wheels of the semi-trailer truck 102, the vertical bars 500 and 502 can both be moved to the outside of the tandem wheels and still be within the spirit of the invention.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

We claim:

1. A system for transporting a plurality of automobiles on a stinger semi-trailer with a standard class 8 semi-trailer truck with a high mount fifth wheel above the rear wheels, the system comprising:
a higher assembly with two upper side bars and at least two cross bars attaching the upper side bars, wherein at least one cross bar includes a sliding adjustable kingpin that latches with the high fifth wheel;
a lower assembly connected to the higher assembly with a lower fifth wheel that is attachable to stinger semi-trailer.

2. The system of claim 1 wherein the stinger semi-trailer includes the capacity to carry at least five vehicles;

3. The system of claim 1 wherein the higher assembly includes the capacity to carry at least one vehicle on the standard class 8 semi-trailer truck.
